(19) United States
(12) Patent Application Publication
(10) Pub. No.: US 2024/0391289 A1
(43) Pub. Date: Nov. 28, 2024

(54) SYSTEMS AND METHODS FOR CONTROLLING ACTIVE ROLL CONTROL SYSTEMS IN VEHICLES

(71) Applicant: GM GLOBAL TECHNOLOGY OPERATIONS LLC, Detroit, MI (US)

(72) Inventors: Christopher J. METTRICK, Whitby (CA); Brian K. SAYLOR, South Lyon, MI (US)

(21) Appl. No.: 18/322,240

(22) Filed: May 23, 2023

(51) Int. Cl. B60G 21/10

(52) U.S. Cl. CPC B60G 21/106; B60G 2400/823; B60G 2401/14; B60G 2401/174; B60G 2401/176

(57) ABSTRACT

A system for controlling an active stabilizer bar in a vehicle includes a stabilizer bar associated with one or more wheels of the vehicle and a control module in communication with the stabilizer bar. The stabilizer bar is configured to be controlled according to a plurality of stiffness modes. Each stiffness mode is associated with a different amount of torque for the stabilizer bar. The control module is configured to control the stabilizer bar to operate according to a first stiffness mode of the plurality of stiffness modes, detect an anomaly in a path of the vehicle, and in response to detecting the anomaly, control the stabilizer bar to operate according to a second stiffness mode of the plurality of stiffness modes, the second stiffness mode being different than the first stiffness mode. Other examples systems and methods for controlling active stabilizer bars in vehicles are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for controlling active roll control systems in moving vehicles, and more particularly to procedures for detecting road anomalies and controlling active roll control systems in response to the detected road anomalies.

A vehicle includes a suspension system having stabilizer bars in the front and rear of the vehicle. Each stabilizer bar generates torque to counteract a tilting or roll effect of the vehicle chassis and to maintain stability of the vehicle and/or prevent roll over when the vehicle is turning. The stabilizer bars may function mechanically such that torque is naturally generated through twisting of the bars when the vehicle is turning. Alternatively, the stabilizer bars may function electromechanically such that the amount of torque is actively controlled when the vehicle is turning. Such arrangements are referred to as active roll control systems.

### SUMMARY

A system for controlling an active stabilizer bar in a vehicle includes a stabilizer bar associated with one or more wheels of the vehicle and a control module in communication with the stabilizer bar. The stabilizer bar is configured to be controlled according to a plurality of stiffness modes. Each stiffness mode is associated with a different amount of torque for the stabilizer bar. The control module is configured to control the stabilizer bar to operate according to a first stiffness mode of the plurality of stiffness modes, detect an anomaly in a path of the vehicle, and in response to detecting the anomaly, control the stabilizer bar to operate according to a second stiffness mode of the plurality of stiffness modes, the second stiffness mode being different than the first stiffness mode.

In other features, the anomaly in the path of the vehicle includes at least one of a pothole, a bump, and a curve.

In other features, the system further includes a detection module in communication with the control module and configured to detect the anomaly in the path of the vehicle.

In other features, the detection module includes at least one of a radar sensor, a lidar sensor, an ultrasonic sensor, and a camera.

In other features, the control module is configured to receive a signal indicative of the anomaly from another control module external to the vehicle, and detect the anomaly in the path of the vehicle based on the received signal.

In other features, the control module is configured to determine a distance between the detected anomaly and the vehicle, and in response to the distance being less than or equal to a defined threshold, control the stabilizer bar to operate according to the second stiffness mode of the plurality of stiffness modes.

In other features, the control module is configured to determine an amplitude of the detected anomaly, and in response to the vehicle reaching the amplitude of the detected anomaly, control the stabilizer bar to operate according to a third stiffness mode of the plurality of stiffness modes.

In other features, the third stiffness mode is different than the second stiffness mode.

In other features, the anomaly in the path of the vehicle is a pothole, and the amount of torque associated with the second stiffness mode is greater than the amount torque associated with the third stiffness mode.

In other features, the anomaly in the path of the vehicle is a bump, and the amount of torque associated with the second stiffness mode is less than the amount torque associated with the third stiffness mode.

In other features, the system further includes a steering wheel angle sensor in communication with the control module. The steering wheel angle sensor is configured to detect movement of a steering wheel in the vehicle.

In other features, the control module is configured to receive a signal from the steering wheel angle sensor indicating movement of the steering wheel, and detect the anomaly in the path of the vehicle based on the received signal from the steering wheel angle sensor.

In other features, the amount of torque associated with the first stiffness mode is less than the amount torque associated with the second stiffness mode.

A method for controlling an active stabilizer bar associated with one or more wheels of a vehicle includes controlling a stabilizer bar to operate according to a first stiffness mode of a plurality of stiffness modes. Each stiffness mode is associated with a different amount of torque for the stabilizer bar. The method further includes detecting an anomaly in a path of the vehicle, and in response to detecting the anomaly, controlling the stabilizer bar to operate according to a second stiffness mode of the plurality of stiffness modes. The second stiffness mode is different than the first stiffness mode.

In other features, the anomaly in the path of the vehicle includes at least one of a pothole, a bump, and a curve.

In other features, the method further includes receiving a signal indicative of the anomaly from another control module external to the vehicle, and detecting the anomaly in the path of the vehicle includes detecting the anomaly based on the received signal.

In other features, detecting the anomaly in the path of the vehicle includes detecting the anomaly with at least one of a radar sensor, a lidar sensor, an ultrasonic sensor, and a camera.

In other features, the method further includes determining a distance between the detected anomaly and the vehicle, and controlling the stabilizer bar to operate according to the second stiffness mode includes controlling the stabilizer bar to operate according to the second stiffness mode in response to the distance being less than or equal to a defined threshold.

In other features, the method further includes determining an amplitude of the detected anomaly, and in response to the vehicle reaching the amplitude of the detected anomaly, controlling the stabilizer bar to operate according to a third stiffness mode of the plurality of stiffness modes.

In other features, the third stiffness mode being different than the second stiffness mode.

In other features, the anomaly in the path of the vehicle is a pothole, and the amount of torque associated with the second stiffness mode is greater than the amount torque associated with the third stiffness mode.

In other features, the anomaly in the path of the vehicle is a bump, and the amount of torque associated with the second stiffness mode is less than the amount torque associated with the third stiffness mode.

In other features, the method further includes receiving a signal from a steering wheel angle sensor indicating movement of a steering wheel in the vehicle, and detecting the anomaly in the path of the vehicle includes detecting the anomaly based on the received signal from the steering wheel angle sensor.

A system for controlling an active stabilizer bar in a vehicle includes a stabilizer bar associated with one or more wheels of the vehicle and a control module in communication with the stabilizer bar. The stabilizer bar is configured to be controlled according to a plurality of stiffness modes. Each stiffness mode is associated with a different amount of torque for the stabilizer bar. The control module is configured to control the stabilizer bar to operate according to a first stiffness mode of the plurality of stiffness modes, detect an anomaly in a path of the vehicle, determine a distance between the detected anomaly and the vehicle, determine an amplitude of the detected anomaly, in response to the distance being less than or equal to a defined threshold, control the stabilizer bar to operate according to a second stiffness mode of the plurality of stiffness modes, and in response to the vehicle reaching the amplitude of the detected anomaly, control the stabilizer bar to operate according to a third stiffness mode of the plurality of stiffness modes.

In other features, the second stiffness mode is different than the first stiffness mode.

In other features, the third stiffness mode is different than the second stiffness mode.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system including a control module for controlling active stabilizer bars according to the present disclosure;

FIG. 2 is a functional block diagram of a vehicle including portions of the system of FIG. 1 according to the present disclosure;

FIG. 3 is a functional block diagram of multiple vehicles, where one vehicle detects a road anomaly and another vehicle is later informed of the detected road anomaly, according to the present disclosure;

FIG. 4 is a flowchart of an example control process for controlling an active stabilizer bar of a vehicle according to the present disclosure; and

FIG. 5 is a flowchart of another example control process for controlling an active stabilizer bar of a vehicle according to the present disclosure.

In the drawings, reference numbers may be reused to identify similar and/or identical elements.

### DETAILED DESCRIPTION

A vehicle includes one or more active roll control (ARC) systems that actively control an amount of torque of a stabilizer bar to counteract a tilting or roll effect of the vehicle chassis and to maintain stability and/or prevent roll over of the vehicle. Typically, the vehicle includes two stabilizer bars, one in the front of the vehicle and one in the rear of the vehicle. In such examples, each stabilizer bar may be actively controlled to change the amount of torque applied to each wheel. When moving, the vehicle may encounter a pothole, a bump, etc. In such scenarios, one or more of the ARC systems may react to the encountered pothole, bump, etc. and rely on a state estimator to control the amount of torque for the associated stabilizer bar based on wheel position and wheel acceleration information of the vehicle. However, in such scenarios, the ARC system may have a limited opportunity to react to the encountered pothole, bump, etc. due to, for example, the speed of the vehicle, the size of the pothole, the bump, etc. For example, if an encountered pothole has a size (e.g., a length) of 1 meter and the vehicle is traveling at 60 kilometers per hour, the vehicle will move past the pothole in 50 milliseconds. As such, due to its reactive nature, the conventional ARC system may have a limited amount of time to react to the encountered pothole.

The systems and methods according to the present disclosure provide accurate detection and tracking of a road anomaly (e.g., a pothole, a bump, a curve, etc.), and then control of one or more vehicle stabilizer bars in response to the detected road anomaly. As such, forewarned notice of an upcoming road anomaly may be provided, thereby enabling the systems and methods to recognize when it is desirable for an ARC system to provide stabilizer bar torque, minimize stabilizer bar torque, etc. For example, the systems and methods herein may control a stabilizer bar to operate according to a stiffness mode (e.g., a default stiffness mode, a torque rejection mode, a torque mode, etc.), detect an anomaly in a path of the vehicle, and then in response to detecting the anomaly, control the stabilizer bar to operate according to another stiffness mode (e.g., a torque rejection mode, a torque mode, etc.). In this manner, the ARC system may be controlled in different modes according to a detected road anomaly to control the amount of torque (e.g., no or minimal torque, decreased torque, increased torque, etc.) provided to the stabilizer bar. With the proactive control of the ARC systems, the ride and comfort of moving vehicles (e.g., autonomous vehicles, semi-autonomous vehicles, non-autonomous vehicles, etc.) may be improved as compared to conventional reactive ARC systems.

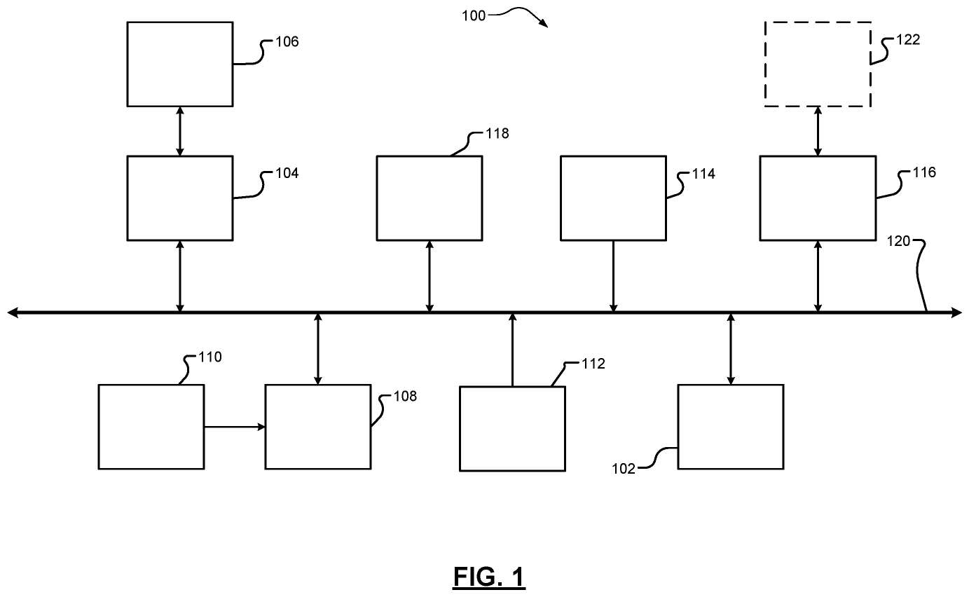

Referring now to FIG. 1, a functional block diagram of an example vehicle system 100 is presented. The vehicle system 100 may be for any suitable vehicle having an ARC system, such as an electric vehicle (e.g., a pure electric vehicle, a plug-in hybrid electric vehicle, etc.), an internal combustion engine vehicle, etc. Additionally, the vehicle system may be applicable to an autonomous vehicle, a semi-autonomous vehicle, or a non-autonomous vehicle.

As shown in FIG. 1, the vehicle system 100 generally includes a control module 102, ARC systems each having an ARC module 104 and a stabilizer bar 106, a steering control module 108, a steering wheel angle sensor 110, a velocity sensor 112, a detection module 114, and a communication interface 116. While the vehicle system 100 is described herein as having a single ARC module associated with each stabilizer bar, it should be appreciated that one ARC module may be associated with multiple stabilizer bars if desired. Additionally, although the vehicle system 100 is shown as including one detection module and one communication interface, it should be appreciated that in some embodiments, the system 100 may include multiple detection modules and/or multiple communication interfaces.

The above-mentioned modules and sensors of the vehicle system 100 may share parameters via a network 120, such as a controller area network (CAN). A CAN may also be referred to as a car area network. For example, the network 120 may include one or more data buses. Various parameters may be made available by a given module to other modules via the network 120.

In various embodiments, the control module 102 may control an engine and/or motor. For example, in an internal combustion engine vehicle, the control module 102 may control actuation of engine actuators, such as a throttle valve, one or more spark plugs, one or more fuel injectors, valve actuators, camshaft phasers, an exhaust gas recirculation valve, one or more boost devices, and other suitable engine actuators. In some types of vehicles (e.g., electric vehicles), the engine may be omitted. If the vehicle is an electric vehicle, the control module 102 may control an electric motor. For example, the electric motor may act as either a generator or as a motor at a given time. When acting as a generator, the electric motor converts mechanical energy into electrical energy. The electrical energy can be, for example, used to charge a battery via a power control device. When acting as a motor, the electric motor generates torque that may be used, for example, to supplement or replace torque output by the engine.

The steering control module 108 controls steering/turning of wheels of the vehicle, for example, based on a driver turning a steering wheel within the vehicle and/or steering commands from one or more vehicle control modules. The steering wheel angle (SWA) sensor 110 may monitor a rotational position, movement, etc. of the steering wheel and generate a SWA signal based on the position, movement, etc. of the steering wheel. The generated SWA signal is then provided to the steering control module 108. As an example, the steering control module 108 may control vehicle steering via an electronic power steering (EPS) motor based on the generated SWA signal. However, the vehicle may include another type of steering system. The steering control module 108 and/or the EPS motor may then provide the SWA signal to the control module 102, the ARC modules 104, and/or another control module in the vehicle.

The velocity sensor 112 monitors the speed (e.g., miles per hours, kilometers per hour, etc.) of the vehicle. For example, the velocity sensor 112 may include a vehicle speed sensor (VSS) that measures a transmission/transaxle output or wheel speed. The velocity sensor 112 may then provide a signal representing the velocity of the vehicle to the control module 102, the ARC modules 104, and/or another control module in the vehicle. In other examples, the control module 102 may receive a signal representing an accelerator pedal position of the vehicle. In such examples, the control module 102 may determine or calculate the velocity of the vehicle based on the accelerator pedal position.

The ARC modules 104 of the ARC systems actively control an amount of torque of the stabilizer bars 106. For example, one of the stabilizer bars 106 is positioned in the front of the vehicle to work with a front suspension system and one or more front wheels of the vehicle. Another one of the stabilizer bars 106 is positioned in the rear of the vehicle to work with a rear suspension system and one or more rear wheels of the vehicle. In such examples, the ARC modules 104 control how much torque is provided by the stabilizer bars 106 based on, for example, signals from the control module 102 and/or another control module in the vehicle, to counteract a tilting or roll effect of the vehicle chassis and to maintain stability of the vehicle and/or prevent roll over when the vehicle is turning.

In various embodiments, any one of stabilizer bars 106 may be controlled to operate according to multiple different stiffness modes. In such examples, each stiffness mode may be associated with a different amount (e.g., a specific amount, a varying amount, etc.) of torque for the stabilizer bar 106. For example, the stabilizer bar 106 may be controlled in a torque rejection mode in which no torque or a minimal amount of torque is provided, a torque mode where a defined amount of torque is provided, etc. In some examples, either one of the torque rejection mode or the torque mode may be considered a default stiffness mode.

With continued reference to FIG. 1, the vehicle system may further include a memory circuit 118 for storing various parameters associated with the vehicle. More specifically, the memory circuit 118 may store a variety of torque values associated with the stiffness modes of the stabilizer bars 106. In such examples, the stored torque values may correspond to different types of road anomalies (e.g., evaluated road surfaces, recessed road surfaces, etc.), the size of the road anomalies, etc. As such, and as further explained herein, when a particular road anomaly is detected and one of the stabilizer bars 106 is controlled according to a particular stiffness mode, a corresponding stored torque may be preloaded for an actuator associated with the stabilizer bar 106.

The memory circuit 118 may be in communication with one or more of the above-mentioned modules of the vehicle system 100 via the network 120. For example, the memory circuit 118 may communicate with the control module 102 and/or the ARC modules 104 via the network 120 as shown in FIG. 1 and/or via another network. In other embodiments, the control module 102 and/or the ARC modules 104 may include the memory circuit 124 or portions thereof.

In various embodiments, the control module 102 and/or the ARC modules 104 may control the stabilizer bars 106 to operate according to a particular stiffness mode. For example, the control module 102 and/or the ARC modules 104 may control one of the stabilizer bars 106 to operate in a default stiffness mode, such as a torque rejection mode, a torque mode, etc. as explained above. Then, at a later time, the control module 102 and/or the ARC modules 104 may control the stabilizer bar 106 to operate in another stiffness mode, thereby changing the amount of torque applied to the stabilizer bar 106. This change in control of the stiffness modes may be in response to, for example, the detection of a road anomaly in the path of the vehicle.

The control module 102 may detect or otherwise become aware of an anomaly in the path of the vehicle. The anomaly may be detected through the use of modules internal to the vehicle. For instance, the anomaly may be detected with the detection module 114. In such examples, the detection module 114 may transmit a signal indicative of the detected anomaly to the control module 102 (via the network 120).

For example, the detection module 114 may generally detect and track objects in the path of the vehicle. In various embodiments, the detected objects may include, for example, other vehicles, individuals, animals, road signs, road anomalies, etc. In such examples, the road anomalies may include evaluated road surfaces (e.g., bumps, frost heave events, etc.), recessed road surfaces (e.g., potholes, etc.), road changes (e.g., curves in a road, etc.), etc. For example, the detection module 114 may include one or more detection devices, such as a radar sensor, a lidar sensor, an ultrasonic sensor, a camera, etc. mounted on the vehicle. During operation, a detection device of the detection module 114 may emit waves (e.g., light waves, ultrasonic sound waves, microwave signals, etc.) and then receive reflected waves to detect road anomalies (e.g., bumps, potholes, curves, etc.) or other objects. In some examples, the detection module 114 may initially detect an object up to ten to twenty meters away from the vehicle depending on, for example, the speed of the vehicle.

In various embodiments, the detection module 114 and/or the control module 102 may recognize the road anomalies through various mechanisms. For example, data collected by the detection module 114 may be used to create surface profiles of the road and then processed (e.g., image processing, etc.) to detect road anomalies (e.g., irregularities of the road). In some examples, the road anomalies may be recognized through machine learning. For instance, the collected data and/or the created surface profiles of the road may be analyzed along with previously collected data and/or created surface profiles (e.g., from the same or different vehicles) through one or more machine learning algorithms. In doing so, road anomalies and/or features indicative of road anomalies may be detected.

In other embodiments, the anomaly may be detected based on other sensors within the vehicle. For instance, the control module 102 may receive a signal from the SWA sensor 110 indicating movement of the steering wheel, and then detect the anomaly (e.g., a curve, a turn, etc.) based on the received signal from the SWA sensor 110. For example, if the driver moves the steering wheel and/or the steering wheel is autonomously manipulated to steer the vehicle along a curve, avoid an obstacle, change lanes, make a turn, etc., the SWA sensor 110 may detect such movement of the steering wheel before wheels of the vehicle actually turn. Once detected, the SWA sensor 110 may transmit a signal to the control module 102 indicating movement of the steering wheel.

Additionally and/or alternatively, the anomaly may be detected through the use of modules external to the vehicle. For example, the control module 102 may receive a signal indicative of the anomaly from another control module external to the vehicle. In such examples, the signal may be received by the vehicle system 100 via the communication interface 116. For example, the communication interface 116 provides a communication path with other modules, such as modules external to the vehicle. As shown in FIG. 1, the vehicle system 100 may be in communication with an external module 122 via the communication interface 116. In such examples, the control module 102 in the vehicle system 100 may receive one or more signals from the external module 122. Then, the control module 102 may detect or otherwise become aware of the road anomaly based on the received signal(s).

In various embodiments, the external module 122 may be a module (e.g., a control module) in another vehicle, a module in communication with multiple vehicles, etc. For example, one or more vehicles may have previously navigated the same road as the subject vehicle (including the vehicle system 100) is currently traveling on. In some examples, the vehicle(s) may be in front of the subject vehicle with respect to time and/or distance (e.g., a kilometer ahead, twenty minutes ahead, an hour ahead, one or more days ahead, etc.). In such examples, a vehicle may detect the road anomaly (e.g., a pothole, a bump, etc.) with its respective control module, and then provide signal(s) indicative of the anomaly directly to the control module 102 and/or indirectly to the control module 102 via another control module (e.g., a cloud-based module, etc.).

The control module 102 and/or the ARC modules 104 may then control the stabilizer bars 106 to operate according to another, different stiffness mode in response to detecting a road anomaly. For example, when a road anomaly is detected, any one of the stabilizer bars 106 may be temporarily controlled according to a torque rejection mode, where the associated ARC module 104 minimizes the stabilizer torque for the transient event (e.g., traveling over a bump, etc.). In other examples, any one of the stabilizer bars 106 may be temporarily controlled according to a torque mode, where the associated ARC module 104 increases or otherwise provides stabilizer torque for the transient event (e.g., traveling over a pothole, etc.).

In some examples, the control module 102 and/or the ARC modules 104 may control the stabilizer bars 106 to operate according to a default stiffness mode, and then change stiffness modes. For example, one of the stabilizer bars 106 may be normally controlled according to a torque rejection mode. In response to detecting a road anomaly which causes the vehicle to turn (e.g., a curve, a turn, avoidance of an obstacle, lane change, etc. as explained above), the stabilizer bar may be temporarily controlled according to a torque mode or an active roll mode, where the associated ARC module 104 may increase the stabilizer torque to minimize roll and improve handling. Such control may be particularly useful in autonomous vehicles. In such examples, the ride and handling throughout the drive (e.g., during straight ahead driving and turns) may be improved. Additionally, in autonomous vehicles, power may be generated when operating in the torque rejection mode. As such, by maximizing time spent in the torque rejection mode (e.g., the default, normal stiffness mode), the range of the vehicles may be increased.

In various embodiments, the control module 102 and/or the ARC modules 104 may control the stabilizer bars 106 to operate according to another, different stiffness mode based on a distance between the detected anomaly and the vehicle. For example, the control module 102 may determine a distance between the detected anomaly and the vehicle. This determination may be made based on received data from the detection module 114 and/or other sensors in the system 100. For example, the control module 102 may determine the relative distance of the detected anomaly based on the period of time between when a detection device emits waves and receives reflected waves, the speed of the vehicle, etc.

Then, the control module 102 and/or the ARC modules 104 may control the stabilizer bars 106 to operate according to another, different stiffness mode in response to the determined distance being less than or equal to a defined threshold. For example, in some cases, it may be desirable to change stiffness modes a minimal distance from or at the anomaly (e.g., the pothole, the bump, etc.) to maintain the ride and handling of the vehicle. In such examples, the distance between the detected anomaly and the vehicle may be determined multiple times (e.g., periodically, continually, etc.) and compared to the defined threshold (e.g., 3 meters, 2 meters, 1.5 meters, 1 meter, 0.5 meters, zero, etc.). Once the determined distance reaches or falls below the defined threshold, the control module 102 and/or the ARC modules 104 may control the stabilizer bars 106 to operate according to another, different stiffness mode.

In various embodiments, any one of the stabilizer bars 106 may be temporarily controlled according to one stiffness mode in response to a detected road anomaly and then controlled according to another stiffness mode after a condition is met. For example, the control module 102 may determine a type of the anomaly and a size of the anomaly. In such examples, the control module 102 may determine whether the detected anomaly is a positive event (e.g., an evaluated road event) or a negative event (e.g., a recessed road event) and an amplitude of the detected anomaly based on the collected data from the detection module 114, the created surface profiles, etc. As one example, the control module 102 may determine an estimated amplitude of the detected anomaly based on location data (e.g., X, Y, Z location data) associated with the reflected waves, the relative distance of the detected object, etc.

Then, in response to the vehicle reaching the amplitude (e.g., the peak displacement) of the detected anomaly, the control module 102 and/or the ARC modules 104 may control the stabilizer bars 106 to operate in a different stiffness mode. As such, the stabilizer bar 106 may operate in multiple stiffness modes while the particular wheel of the vehicle encounters the anomaly. In other words, the stabilizer bar 106 may operate in one stiffness mode when the particular wheel of the vehicle initially encounters the anomaly, and another stiffness mode after the particular wheel of the vehicle reaches the peak of the anomaly.

For example, any one of the stabilizer bars 106 may be normally controlled in a torque rejection mode. If the control module 102 detects a road anomaly and determines the anomaly is a pothole or another recessed or negative road event, the stabilizer bar 106 may be temporarily controlled according to a torque mode, where the associated ARC module 104 increases, provides, etc. the stabilizer torque. Then, after the wheel/tire reaches the peak displacement (e.g., the amplitude) of the pothole, the stabilizer bar 106 may be controlled according to another stiffness mode, such as the torque rejection mode or another mode to reduce, eliminate, etc. the stabilizer torque. If, however, the control module 102 determines the anomaly is a bump or another evaluated or positive road event, the stabilizer bar 106 may be temporarily controlled according to a stiffness mode to reduce, eliminate, etc. the stabilizer torque. Then, after the wheel/tire reaches the peak displacement (e.g., the amplitude) of the bump, the stabilizer bar 106 may be controlled according to another stiffness mode, such as a torque mode or another mode to increase, provide, etc. the stabilizer torque.

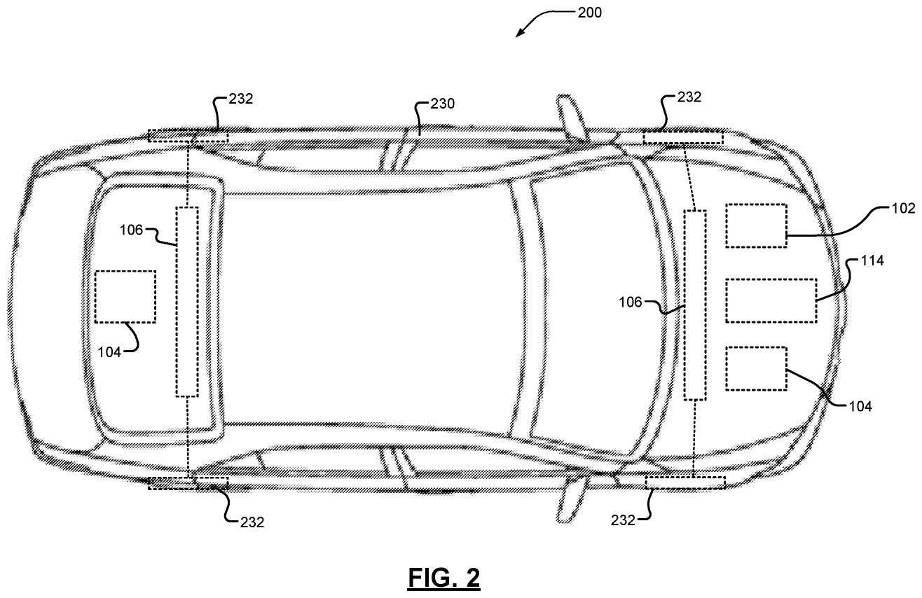

In various embodiments, the vehicle system of FIG. 1 or portions thereof may be implemented in any suitable vehicle. For example, FIG. 2 is a top view of the example vehicle 200 including a body 230 arranged on a chassis (not shown), four wheels 232, and a portion of the vehicle system 100 of FIG. 1. More specifically, the vehicle 200 is shown as including the control module 102, the detection module 114, the ARC modules 104, and the stabilizer bars 106 of FIG. 1. As shown, one of the stabilizer bars 106 is positioned in the front of the vehicle 200 and the other stabilizer bar 106 is positioned in the rear of the vehicle 200. Although not shown in FIG. 2, the vehicle 200 may also include the other modules and sensors referenced above relative to FIG. 1.

In the embodiment of FIG. 2, the vehicle 200 may be any suitable type of vehicle. For example, the vehicle 200 may be an electric vehicle (e.g., a pure electric vehicle, a plug-in hybrid electric vehicle, etc.), an internal combustion engine vehicle, etc. Additionally, the vehicle 200 may be an autonomous vehicle, a semi-autonomous vehicle, or a non-autonomous vehicle.

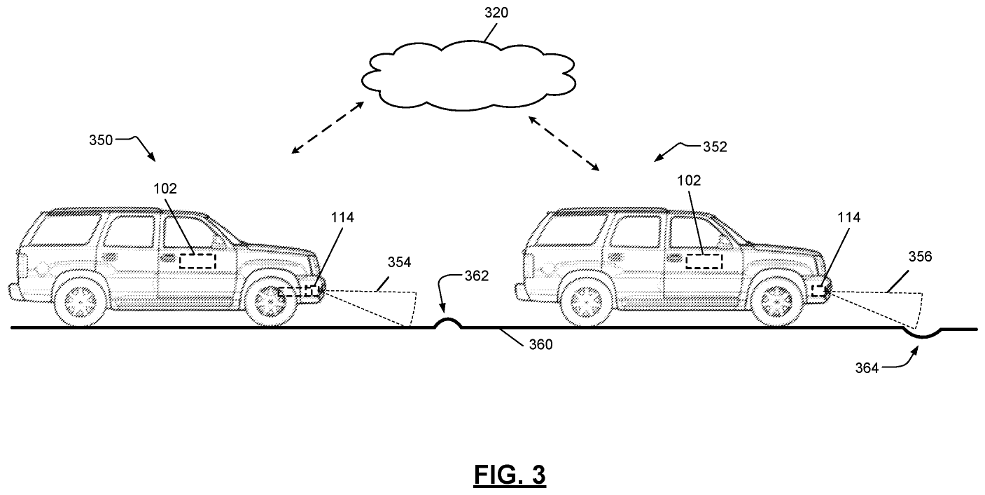

FIG. 3 depicts two vehicles 350, 352 on a road surface 360, in which one of the vehicles 352 detects a road anomaly and the other vehicle 350 is informed of the detected road anomaly. As shown, the vehicles 350, 352 each include a portion of the vehicle system 100 of FIG. 1. For example, each vehicle 350, 352 is shown as including the control module 102 and the detection module 114 of FIG. 1. Although not shown in FIG. 3, one or both vehicles 350, 352 may also include the other modules and sensors referenced above relative to FIG. 1.

In the example of FIG. 3, the detection module 114 for each vehicle 350, 352 may be a lidar sensor, a radar sensor, an ultrasonic sensor, a camera, etc. positioned in or adjacent to a bumper of the vehicle 350, 352. As shown, the detection module 114 of the vehicle 350 has a field of view 354 and the detection module 114 of the vehicle 352 has a field of view 356.

In various embodiments, the vehicle 352 may detect road anomalies along the road surface 360, as explained herein. For example, the vehicle 352 (via its detection module 114, control module 102, etc.) may detect a bump 362 and a pothole 364. In such examples, one or more stabilizer bars in the vehicle 352 may be controlled according to different stiffness modes when a wheel of the vehicle 352 encounters and traverses across the bump 362 and/or the pothole 364, as explained above. Additionally, the vehicle 352 may provide one or more signals indicative of the bump 362 and/or the pothole 364 to the control module 102 of the vehicle 350 via a communication network 320 and/or another control module in communication with the vehicles 350, 352. Then, the control module 102 of the later arriving vehicle 350 may be informed of the bump 362 and/or the pothole 364, and react in a suitable manner as explained above.

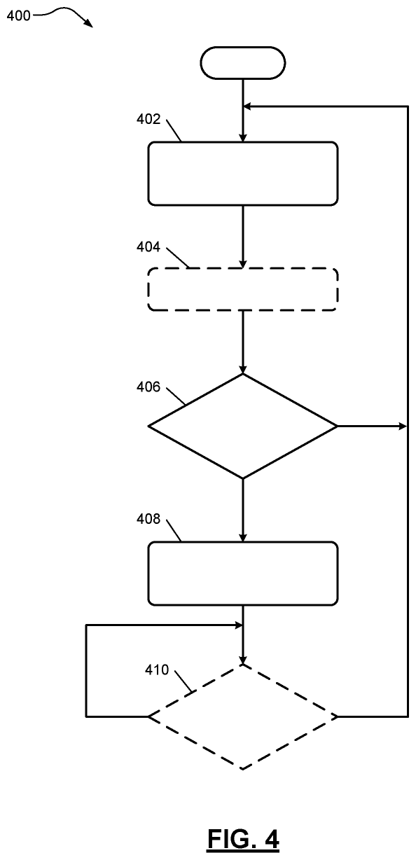

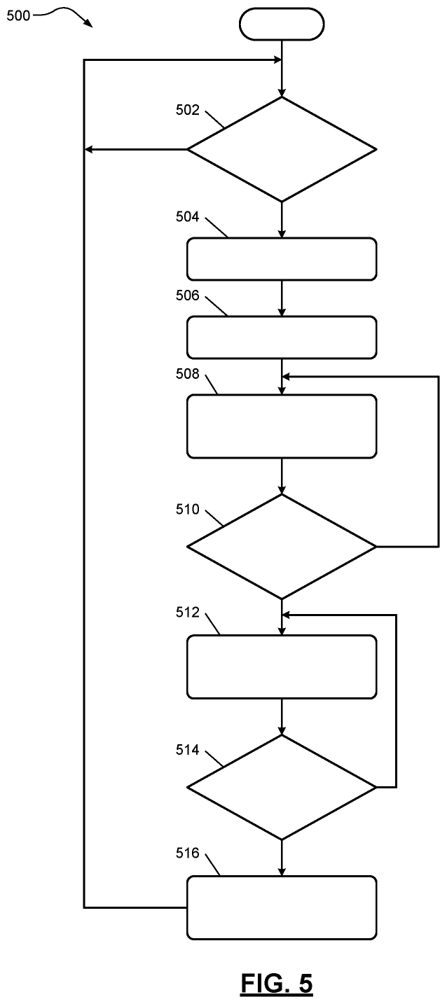

FIGS. 4-5 illustrate example control processes 400, 500 employable by the vehicle system 100 of FIG. 1 for controlling any one of the active stabilizer bars 106 associated with one or more wheels of a vehicle while the vehicle is moving. Although the example control processes 400, 500 are described in relation to the system 100 of FIG. 1 including the control module 102, any one of the control processes 400, 500 may be employable by any suitable system. Each control process 400, 500 may start when the system is powered-on, the vehicle is powered-on, and/or at another suitable time, and end when the vehicle comes to a stop, is powered-off, and/or at another suitable time.

As shown in FIG. 4, control begins at 402 where the control module 102 (and/or the appropriate ARC module 104) controls one or both stabilizer bars 106 to operate according to a particular stiffness mode. For example, and as explained herein, each stabilizer bar 106 may be controlled in a default stiffness mode, such as a torque rejection mode, a torque mode, etc. In some examples, a corresponding torque for the particular stiffness mode may be stored in memory (e.g., the memory circuit 118) and preloaded for one or more actuators associated with the stabilizer bars 106. Control then proceeds to 404.

At 404, the control module 102 may optionally receive data from one or more sources. For example, and as explained herein, the control module 102 may receive collected data and/or road surface profiles from sensors associated with the vehicle, such as a detection device (e.g., a radar sensor, a lidar sensor, an ultrasonic sensor, a camera, etc.) of one or more detection modules 114, the SWA sensor 110, the velocity sensor 112, etc. Additionally and/or alternatively, the control module 102 may receive data from one or more modules external to the vehicle, such as a control module associated with another vehicle, a control module in communication with multiple vehicles, etc. Control then proceeds to 406.

At 406, the control module 102 detects whether a road anomaly is in the path of one of the wheels/tires of the vehicle, as explained herein. In various embodiments, the control module 102 may make this determination based on the received data and/or road surface profile. For example, the control module 102 may detect a road anomaly based on information from the one or more detection modules 114, machine learning techniques, etc. In other embodiments, the control module 102 may detect a road anomaly based on signals from the SWA sensor 110 (e.g., indicating an impending change in direction of the vehicle). In still other embodiments, the control module 102 may detect a road anomaly based on feedback from other vehicles. If a road anomaly is detected, control proceeds to 408. Otherwise, control may return to 402, where the stabilizer bar 106 may remain controlled in its default stiffness mode.

At 408, the control module 102 (and/or the appropriate ARC module 104) controls one or both stabilizer bars 106 associated with the effected wheel(s)/tire(s) of the vehicle, to operate according to another stiffness mode in response to the detected road anomaly. For example, and as explained herein, if the detected road anomaly is a pothole, the control module 102 may change the stiffness mode for the stabilizer bar 106 from a torque rejection mode to a torque mode, where the associated ARC module 104 may increase, provide, etc. the stabilizer torque. A similar change in the stiffness mode may occur when the detected road anomaly is an impending change in direction of the vehicle. In other examples, if the detected road anomaly is a bump, the control module 102 may change the stiffness mode for the stabilizer bar 106 to reduce the stabilizer torque. In such examples, a corresponding stored torque for the detected road anomaly and the particular stiffness mode may be preloaded for one or more actuators associated with the stabilizer bars 106.

Control may then proceed to 410, where the control module 102 may optionally determine whether the effected wheel(s)/tire(s) or generally the vehicle has traversed the detected road anomaly. If not, control may return to 410. If so, control may return to 402, where the stabilizer bar 106 may again be controlled in its default stiffness mode. In other embodiments, control may instead wait a period of time (e.g., based on the speed of the vehicle) to ensure the effected wheel(s)/tire(s) or the vehicle has traversed the detected road anomaly, and then return to 402.

As shown in FIG. 5, control begins at 502 where the control module 102 detects whether a road anomaly may be in the path of one of the wheels/tires of the vehicle, as explained herein. If not, control returns to 502. If so, control proceeds to 504, 506, 508.

At 504, 506, 508, the control module 102 may determine multiple characteristics associated with the detected road anomaly. For example, at 504, the control module 102 may determine a type of the road anomaly. In such examples, the control module 102 may determine whether the detected road anomaly is positive event (e.g., an evaluated road event, such as a bump, a frost heave event, etc.), a negative event (e.g., a recessed road event, such as a pothole, etc.), etc. At 506, the control module 102 may determine the size of the road anomaly. For example, the control module 102 may determine a peak displacement (e.g., an amplitude), a length, etc. of the positive or negative event. Further, at 508, the control module 102 may determine a distance between the detected road anomaly and the vehicle. Such determinations at 504, 506, 508 may be made based on received data from a detection device of one or more detection modules, other sensors in the system 100, machine learning algorithms, etc. as explained herein.

Control then proceeds to 510, where the control module 102 determines whether the determined distance is less than or equal to a defined threshold. In various embodiments, the defined threshold may be, for example, 3 meters, 2 meters, 1.5 meters, 1 meter, 0.5 meters, zero, etc. In some examples, the defined threshold may change during the course of travel based on, for example, the speed of the vehicle. If no at 510, control returns to 508 to again determine a distance between the detected road anomaly and the vehicle. If yes at 510, control proceeds to 512.

At 512, the control module 102 (and/or the appropriate ARC module 104) controls one or both stabilizer bars 106 associated with the effected wheel(s)/tire(s) of the vehicle, to operate according to a stiffness mode in response to the detected road anomaly as explained herein. In such examples, a corresponding stored torque for the detected road anomaly, its characteristics, and the particular stiffness mode may be preloaded for one or more actuators associated with the stabilizer bars 106. For example, the memory circuit 118 may store various torque values for different types of road anomalies (e.g., positive and negative events), different sizes of the road anomalies, etc. Control proceeds to 514.

At 514, the control module 102 determines whether the effected wheel(s)/tire(s) has reached the peak displacement of the road anomaly (e.g., the positive or negative event). This may be determined based on the size of the road anomaly, the speed of the vehicle, etc. If no at 514 (e.g., the effected wheel(s)/tire(s) are on the upward slope of a bump, the downward slope of a pothole, etc.), control may return to 512 where the effected stabilizer bar 106 may remain controlled in its current stiffness mode. If yes at 514, control proceeds to 516.

At 516, the control module 102 (and/or the appropriate ARC module 104) controls one or both stabilizer bars 106 associated with the effected wheel(s)/tire(s) of the vehicle, to operate according to another stiffness mode as explained herein. In such examples, a corresponding stored torque for the detected road anomaly, its characteristics, and the particular stiffness mode may be preloaded for one or more actuators associated with the stabilizer bars 106. Control may then return to 502.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for controlling an active stabilizer bar in a vehicle, the system comprising:
a stabilizer bar associated with one or more wheels of the vehicle, the stabilizer bar configured to be controlled according to a plurality of stiffness modes, each stiffness mode associated with a different amount of torque for the stabilizer bar; and
a control module in communication with the stabilizer bar, the control module configured to:
control the stabilizer bar to operate according to a first stiffness mode of the plurality of stiffness modes;
detect an anomaly in a path of the vehicle; and
in response to detecting the anomaly, control the stabilizer bar to operate according to a second stiffness mode of the plurality of stiffness modes, the second stiffness mode being different than the first stiffness mode.

2. The system of claim 1, wherein the anomaly in the path of the vehicle includes at least one of a pothole, a bump, and a curve.

3. The system of claim 1, further comprising a detection module in communication with the control module and configured to detect the anomaly in the path of the vehicle.

4. The system of claim 3, wherein the detection module includes at least one of a radar sensor, a lidar sensor, an ultrasonic sensor, and a camera.

5. The system of claim 1, wherein the control module is configured to:
receive a signal indicative of the anomaly from another control module external to the vehicle; and
detect the anomaly in the path of the vehicle based on the received signal.

6. The system of claim 1, wherein the control module is configured to:
determine a distance between the detected anomaly and the vehicle; and
in response to the distance being less than or equal to a defined threshold, control the stabilizer bar to operate according to the second stiffness mode of the plurality of stiffness modes.

7. The system of claim 1, wherein:
the control module is configured to determine an amplitude of the detected anomaly, and in response to the vehicle reaching the amplitude of the detected anomaly, control the stabilizer bar to operate according to a third stiffness mode of the plurality of stiffness modes; and
wherein the third stiffness mode is different than the second stiffness mode.

8. The system of claim 7, wherein the anomaly in the path of the vehicle is a pothole, and wherein the amount of torque associated with the second stiffness mode is greater than the amount torque associated with the third stiffness mode.

9. The system of claim 7, wherein the anomaly in the path of the vehicle is a bump, and wherein the amount of torque associated with the second stiffness mode is less than the amount torque associated with the third stiffness mode.

10. The system of claim 1, further comprising a steering wheel angle sensor in communication with the control module, the steering wheel angle sensor configured to detect movement of a steering wheel in the vehicle, wherein:
the control module is configured to receive a signal from the steering wheel angle sensor indicating movement of the steering wheel, and detect the anomaly in the path of the vehicle based on the received signal from the steering wheel angle sensor; and
the amount of torque associated with the first stiffness mode is less than the amount torque associated with the second stiffness mode.

11. A method for controlling an active stabilizer bar associated with one or more wheels of a vehicle, the method comprising:
controlling a stabilizer bar to operate according to a first stiffness mode of a plurality of stiffness modes, each stiffness mode associated with a different amount of torque for the stabilizer bar;
detecting an anomaly in a path of the vehicle; and
in response to detecting the anomaly, controlling the stabilizer bar to operate according to a second stiffness mode of the plurality of stiffness modes, the second stiffness mode being different than the first stiffness mode.

12. The method of claim 11, wherein the anomaly in the path of the vehicle includes at least one of a pothole, a bump, and a curve.

13. The method of claim 11, further comprising receiving a signal indicative of the anomaly from another control module external to the vehicle, wherein detecting the anomaly in the path of the vehicle includes detecting the anomaly based on the received signal.

14. The method of claim 11, wherein detecting the anomaly in the path of the vehicle includes detecting the anomaly with at least one of a radar sensor, a lidar sensor, an ultrasonic sensor, and a camera.

15. The method of claim 14, further comprising determining a distance between the detected anomaly and the vehicle, wherein controlling the stabilizer bar to operate according to the second stiffness mode includes controlling the stabilizer bar to operate according to the second stiffness mode in response to the distance being less than or equal to a defined threshold.

16. The method of claim 15, further comprising:
determining an amplitude of the detected anomaly; and
in response to the vehicle reaching the amplitude of the detected anomaly, controlling the stabilizer bar to operate according to a third stiffness mode of the plurality of stiffness modes, the third stiffness mode being different than the second stiffness mode.

17. The method of claim 16, wherein the anomaly in the path of the vehicle is a pothole, and wherein the amount of torque associated with the second stiffness mode is greater than the amount torque associated with the third stiffness mode.

18. The method of claim 16, wherein the anomaly in the path of the vehicle is a bump, and wherein the amount of torque associated with the second stiffness mode is less than the amount torque associated with the third stiffness mode.

19. The method of claim 11, further comprising receiving a signal from a steering wheel angle sensor indicating movement of a steering wheel in the vehicle, wherein detecting the anomaly in the path of the vehicle includes detecting the anomaly based on the received signal from the steering wheel angle sensor.

20. A system for controlling an active stabilizer bar in a vehicle, the system comprising:
a stabilizer bar associated with one or more wheels of the vehicle, the stabilizer bar configured to be controlled according to a plurality of stiffness modes, each stiffness mode associated with a different amount of torque for the stabilizer bar; and
a control module in communication with the stabilizer bar, the control module configured to:
control the stabilizer bar to operate according to a first stiffness mode of the plurality of stiffness modes;
detect an anomaly in a path of the vehicle;
determine a distance between the detected anomaly and the vehicle;
determine an amplitude of the detected anomaly;
in response to the distance being less than or equal to a defined threshold, control the stabilizer bar to operate according to a second stiffness mode of the plurality of stiffness modes, the second stiffness mode being different than the first stiffness mode; and
in response to the vehicle reaching the amplitude of the detected anomaly, control the stabilizer bar to operate according to a third stiffness mode of the plurality of stiffness modes, the third stiffness mode being different than the second stiffness mode.
